(19) United States
(12) Patent Application Publication
(10) Pub. No.: US 2026/0308059 A1
(43) Pub. Date: Oct. 8, 2026

(54) CONCRETE RECYCLING

(71) Applicant: Worcester Polytechnic Institute, Worcester, MA (US)

(72) Inventors: Maxwell Markey, Worcester, MA (US); Suzanne F. Scarlata, Worcester, MA (US); Nima Rahbar, Weston, MA (US); Dalton Vassallo, Norwell, MA (US)

(21) Appl. No.: 19/641,093

(22) Filed: Apr. 7, 2026

Related U.S. Application Data
(60) Provisional application No. 63/784,665, filed on Apr. 7, 2025.

(51) Int. Cl. C04B 20/02; C01B 33/113; C01F 7/02; C01F 11/02; C01G 49/02; C04B 11/26; C04B 14/04; C04B 14/36; C04B 18/167

(52) U.S. Cl. CPC C04B 20/023; C01B 33/113; C01F 7/02; C01F 11/02; C01G 49/02; C04B 11/262; C04B 14/04; C04B 14/365; C04B 18/167

(57) ABSTRACT

A carbon favorable process allows for a complete breakdown of concrete into its constituent materials that can be reused for construction thus promoting a circular economy by incorporating the chemical reactions associated with an acidic sulfate attack. This process is promoted by both chemical and electrochemical disassembling of the concrete matrix while preserving the value of the materials. Configurations herein separate the concrete into reusable fractions: gypsum, calcium carbonate, silicate, iron oxide/hydroxide, and cleaned aggregate residue. This approach both preserves and supports a circular economy for concrete by reducing the reliance of virgin material.

### RELATED APPLICATIONS

This patent application claims the benefit under 35 U.S.C. § 119 (e) of U.S. Provisional Patent App. No. 63/784,665, filed Apr. 7, 2025, entitled “CONCRETE RECYCLING,” incorporated herein by reference in entirety.

### BACKGROUND

Concrete is the most widely used construction material in the world. Although it is inexpensive and incredibly strong, it can be inherently brittle, compromising longevity. To date, concrete waste is ground for fill used in roads and concrete blocks but cannot be truly recycled to reform strong structural materials due to the inability to break cement bonds between the aggregates that form intrinsic concrete structure. Concrete exhibits superior compressive strength once in place, however the volume and density of concrete become burdensome when concrete structures reach an end of usable lifespan.

Concrete generally includes sand and aggregate, typically natural gravel and rock materials, and Portland cement, created from high temperature, high carbon footprint processes that operate as a binder to hold the sand and aggregates together. Combination with water commences a chemical curing process with the Portland cement, which adheres the sand and aggregate together as a monolithic structure of cured concrete. Once mixed with water, the concrete takes a viscous fluid form that may be transported, molded, poured and shaped for a brief interval, about 90 minutes, until the curing process begins to solidify the formed concrete, a process which takes about 28 days to completely cure, but which attains substantial strength in about 24-48 hours.

### SUMMARY

A comprehensive process facilitates the chemical dissolution of the structural bonds in concrete using sulfate ions, which precipitates calcium sulfate (gypsum) that can be used in the production of new building materials, including Portland cement and dry wall. By focusing on the downstream product yield from the constituent ingredients, a viable recycling stream is proposed that recovers not only calcium and gypsum products, but also silica, magnesium, aluminum and iron derivatives.

Configurations herein are based, in part, on the observation that concrete is deployed in abundance in infrastructure components such as roads, bridges, and buildings. Large structures and infrastructure projects employ massive amounts of concrete. Unfortunately, conventional approaches to recycling concrete from end-of-life structures suffers from the shortcoming that mechanical activity alone, in the way of crushing, blasting and/or otherwise physically dismantling concrete structures, define the common recycling pathways. Such conventional approaches relegate concrete to properties of physical fill and mass, completely disregarding the energy expended in forming a permanent C—S—H matrix formed by the Portland cement. In addition to the logistical challenges of storing waste concrete in landfills, and the financial burden on construction firms to properly dispose of waste concrete, there are massive quantities of high-quality elements and aggregates trapped in this waste concrete.

Accordingly, configurations herein substantially overcome the shortcomings of conventional, mechanical concrete waste streams by providing a chemical, rather than a mechanical, intervention to recycle concrete into its pure components, such as calcium silicate hydrate (C—S—H) and useful metals such as calcium and iron through reactions initiated by sulfuric acid and by selective precipitation to gypsum, sodium silicate, clay, iron nanoparticles, and calcium carbonate. By providing extraction of both aggregate and constituent binder elements in usable forms, a more complete recycling of constituent components is recovered.

In further detail, a method for recycling concrete including aggregates bound by C—S—H bonds for generating useful constituent building materials includes adding an aqueous acid to waste concrete for generating gypsum from a calcium silicate hydrate (C—S—H) matrix in the concrete, and chemically dissolving the C—S—H matrix to yield an aqueous phase. The concentration of sulfate ions is maintained for favoring precipitation of gypsum rather than ettringite resulting from the dissolution, the gypsum filtered in a solid form for downstream constituent extraction.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a concrete infrastructure recycling environment suitable for use with configurations herein;

FIG. 2 shows a process flow in the environment of FIG. 1 for recycling and extracting constituent materials from the concrete recycling stream of FIG. 1;

FIG. 3 shows an FT-IR spectra of reference calcium phases: Ca(OH)₂, CaCO₃, and gypsum, CaSO₄·2H₂O gathered from the process of FIG. 2;

FIG. 4 shows an FT-IR spectra of Al(OH)₃ and Fe(OH)₃ showing characteristics of metal oxygen and hydroxyl binding vibrations;

FIG. 5 is a schematic diagram of an electrochemical cell operable for the electrodialysis step of FIG. 2;

FIG. 6 shows an FT-IR spectrum of recovered silicate material as in FIG. 2;

FIG. 7 shows an X-ray diffraction (XRD) of product yield from the process of FIG. 2; and

FIG. 8 shows an FT-IR spectrum comparing sodium silicate (red) from the alkali treatment and synthesized silica.

### DETAILED DESCRIPTION

Configuration below depict a comprehensive leaching and electrochemical approach to recycle concrete into its pure components, such as calcium silicate hydrate (C—S—H) and key metals (Fe^{2/3+}, Ca²⁺) through reactions initiated by sulfuric acid and by selective precipitation to gypsum, sodium silicate, clay, iron nanoparticles, and calcium carbonate. The notation C—S—H is employed, rather than specific subscripts, to designate a variable, composition implying no particular stoichiometry. The method is portable, and the reagents used are recyclable. Additionally, the process only requires a modest amount of input energy. The identity and purity of the dissolved components is superior as disclosed below in quantified analytical techniques. This disclosed approach is provided to completely break down concrete matrices to create input products for new, structurally sound concrete supporting a circular economy.

Cement (Portland cement), the key component of concrete, relies heavily on calcium compounds for strength. Calcium carbonate (CaCO₃) is one of the most predominant components in sedimentary rocks accounting for about 4% of the earth's crust. Calcium is expensive, and the vast majority of calcium for construction is obtained from strip mining in a process that involves a large amount of heat and energy. Current methods of cement production rely on expensive limestone quarrying operations that depend on heavy machinery, high labor costs, and continued extraction from depletable deposits resulting in a large carbon footprint and high energy needs. Along with the growing demand for concrete, there is a need for methods for economically viable regeneration and reclamation of material.

Chemically, a typical breakdown of Portland cement includes tricalcium silicate (C₃S, 3CaO·SiO₂; ~55%) as the primary phase. This is followed by dicalcium silicate (C₂S, 2CaO·SiO₂; ~25%), tricalcium aluminate (C₃A, 3CaO·Al₂O₃; ~8%), tetracalcium aluminoferrite (C₄AF, 4CaO·Al₂O₃·Fe₂O₃; ~10%), and lastly calcium sulfate (CaSO₄; ~4%), typically added as gypsum.

In conventional approaches, concrete recycling and reuse involves breaking down of material through a largely mechanical process that involves demolition, transport and crushing waste materials into low value aggregates. These materials have reduced mechanical performance. The end products have limited use and are often down cycled for use as fill rather than refined and reintegrated into high value construction materials. As a result, the cementitious faction that represents the largest source of embodied CO₂ emissions and energy is effectively lost because the energy expended in forming the C—S—H bonds remain.

In contrast, configurations herein describe a process that allows for a complete breakdown of concrete into its constituent materials that can be reused for construction thus promoting a circular economy by incorporating the chemical reactions associated with the sulfate attack as described above. This process is promoted by both chemical and electrochemical disassembling of the concrete matrix while preserving the value of the materials. Configurations herein separate the concrete into reusable fractions: gypsum, calcium carbonate, silicate, iron oxide/hydroxide, and cleaned aggregates that are validated by FT-IR (Fourier Transform Infrared) Spectroscopy, TGA/DTG (Thermal Gravimetric Analysis/Derivative Thermogravimetric Analysis), XRD (X-ray Diffraction), ion exchange chromatography, and Ca²⁺ ion-selective electrodes. The disclosed method both preserves and supports a circular economy for concrete by reducing the reliance of virgin material.

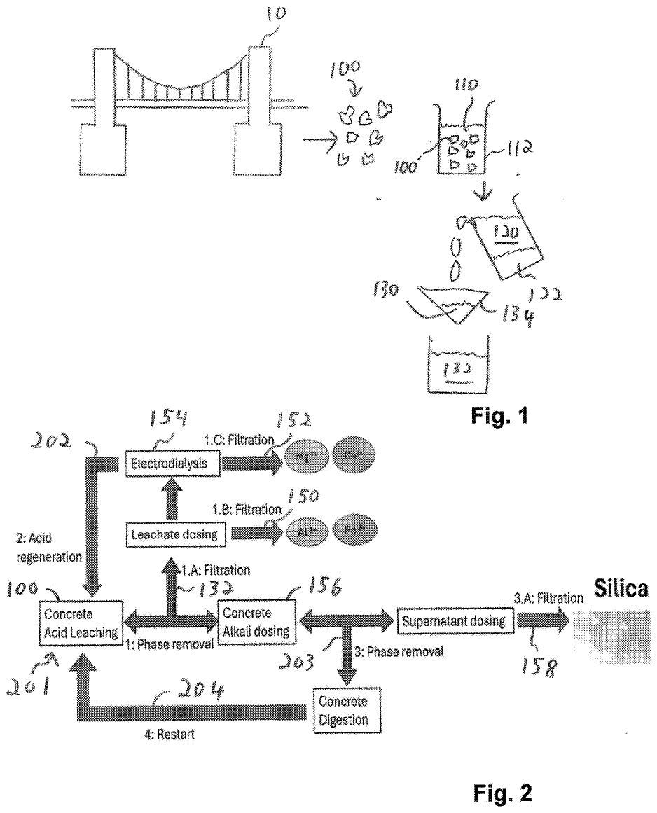

FIG. 1 is a context diagram of a concrete infrastructure recycling environment suitable for use with configurations herein. Briefly, the disclosed approach chemically processes concrete through sequential acid and alkali treatments to separate and recover valuable components. In general, the alkali may be a basic, ionic salt of an alkali metal or alkaline earth metal that dissolves in water to form a solution with a pH greater than 7.0. An intermediate known as pozzolan defines a set of compounds, which in this case are primarily silicate compounds. Each treatment dissolves different components releasing metal cations such as Ca²⁺, Mg²⁺, Fe²⁺, and Al³⁺. Subsequent alkaline treatment enables further separation, producing silica-rich solids and recovering sand and aggregates for reuse. Alkali and acid streams are regenerated and recycled within the process, forming a closed-loop system that maximizes material recovery while reducing waste and enabling CO₂ mineralization.

Referring to FIG. 1, in an example configuration, waste concrete 100 is received from various sources, often end-of-life infrastructure 10 projects which physically dismantle the concrete (and often reinforcing steel) into a granular mass of various sizes, which may be further crushed or agitated into manageable sizes, such as 10-100 mm, however any suitable sizes of waste concrete “chunks” may be accommodated. The method for recycling concrete including aggregates bound by generating useful constituent building materials formed by the C—S—H matrix includes adding an aqueous acid 110 to the waste concrete 100 for generating gypsum from the calcium silicate hydrate (C—S—H) matrix 100′ in the concrete. From a suitable containment 112, the acid chemically dissolves the C—S—H matrix to yield an aqueous phase 120 and a granular or pasty viscous residue 122. The process maintains a concentration of sulfate ions for in the containment 112 for favoring precipitation of gypsum rather than ettringite resulting from the dissolution, and filters the gypsum 130 in a solid form, separable by a filter 134. A liquid phase 132 retains other suitable products for recycling as disclosed further below.

The implemented chemical processes, in a first configuration, demonstrate a conversion of the concrete to gypsum. The gypsum is employed for calcium yield such as calcium carbonate:

Gypsum is produced from the sulfate attack that results from a modest 0.1% sulfuric acid. The gypsum is then dissolved in water around 2.5 g/L:

$${CaSO}_{4} \cdot 2 {H}_{2} O ⇌ {Ca}^{2 +} + {SO}_{4}^{2 -} + 2 {H}_{2} O$$

CO₂ can be dissolved in water forms carbonic acid, or sodium carbonate can be added to the resulting solution:

$${CO}_{2} + {H}_{2} O ⇌ {H}_{2} {CO}_{3}$$

$${Ca}^{2 +} + {Na}_{2} {CO}_{3} \to {CaCO}_{3} + 2 {Na}^{+}$$

NaOH is added to the resulting solution and the carbonate form will be favored:

$${H}_{2} {CO}_{3} + 2 NaOH \to {Na}_{2} {CO}_{3} + 2 {H}_{2} O$$

Due to the lower solubility for calcium carbonate in water when compared to sodium carbonate calcium carbonate will precipitate out of solution:

$${Ca}^{2 +} + {Na}_{2} {CO}_{3} \to {CaCO}_{3} + 2 {Na}^{+}$$

$${Ca}^{2 +} + {CO}_{3}^{2 -} \to {CaCO}_{3}$$

A more comprehensive approach yields a greater array of yields and more complete recycling. Cement is made by quarrying limestone and clay, crushing them into a fine powder, intense heating in a kiln and grinding into a fine powder. Normal Portland cement (NPC) is comprised of calcium, aluminum, magnesium and iron compounds as well as silicates. During cement preparation, calcium oxide (CaO) reacts with water (H₂O) to produce calcium hydroxide (Ca(OH)₂), which is highly reactive. When exposed to a sulfate-rich environment like sewage, several events occur; calcium hydroxide can react with sulfate compounds to produce tricalcium silicate (C—S), C₃S then reacts with H₂SO₄ allowing the formation of gypsum (CaSO₄·2H₂O) which occurs through the series of chemical reactions. C₂S reacts in a similar way but is much slower than C₃S due to less Ca²⁺ available for gypsum formation. This decalcification increases porosity and softens the concrete matrix resulting in cracking and damage. Additionally, tricalcium aluminate (C₃A) becomes hydrated calcium aluminum sulfate material called ettringite. Ettringite (Ca₆Al₂ (SO₄)₃ (OH)₁₂·26H₂O) is only stable at a pH of above 10.7 and is associated with gypsum and aluminate oxides. Below this pH, aluminum exists as aluminum hydroxide. This second configuration extends the decomposition and recovery of additional metals and proceeds as follows:

$$Gypsum formation from sulfate attack {Ca ( OH )}_{2} + {H}_{2} {SO}_{4} {CaSO}_{4} \cdot 2 {H}_{2} O \qquad Eq 1$$

$$Decalcification of C - S - H ( clarity step ) : CH + 2 {H}^{+} \to {Ca}^{2 +} + 2 {H}_{2} O \qquad Eq A1$$

$$C - S - H + 2 \times {H}^{+} \to {SiO}_{2} \cdot {H}_{2} O ( silica gel ) + {Ca}^{2 +} + {H}_{2} O \qquad Eq A2$$

$$Gypsum {precipitation Ca}^{2 +} + {SO}_{4}^{2 -} + 2 {H}_{2} O \to {CaSO}_{4} \cdot 2 {H}_{2} O \qquad Eq A3$$

$$Solubilization of the cement matrix C - S - H + {H}_{2} {SO}_{4} {a}^{‵} {SiO}_{2} \cdot {H}_{2} O + {Ca}^{2 +} + {SO}_{4}^{2 -} \to {CaSO}_{4} \cdot 2 {H}_{2} O \qquad Eq 2$$

$$Sulphate attack on calcium aluminate hydrates ( C - A - H ) \qquad Eq 3$$

$${C}_{3} A + 3 ( CaSO 4 \cdot 2 {H}_{2} O ) + 26 {H}_{2} O {a}^{‵} {C}_{3} A \cdot 3 CS \cdot {H}_{32}$$

$${*}^{} Notes : C - S - H is often approximated as {C}_{3} {S}_{2} {H}_{3} in cement notation ;$$

$$CH = {Ca ( OH )}_{2}$$

$$“ C = CaO , S = {SiO}_{2} , A = {Al}_{2} {O}_{3} , F = {Fe}_{2} {O}_{3} , H = {H}_{2} O , {S}^{-} = {SO}_{3} . ”$$

$$Al 1 precipitation {Al}^{3 +} + 3 {OH}^{-} ⇌ {Al ( OH )}_{3} ( s ) where aluminum hydroxide is stable above pH - {10.7}^{″} {vs}^{″} {Al ( OH )}_{3} at lower pH \qquad Eq 4$$

$$Al 2 ( dissolution at high pH ) : {Al ( OH )}_{3} ( s ) + {OH}^{-} ⇌ {[ {Al ( OH )}_{4} ]}^{-} \qquad Eq 5$$

FIG. 2 shows a process flow in the environment of FIG. 1 for recycling and extracting constituent materials from the concrete recycling stream of FIG. 1. Referring to FIGS. 1 and 2, briefly, the process encompasses 4 sequential stages. At a first stage 201, acid dissolution is followed separation of solid aggregates via controlled neutralization of the supernatant rich in Fe2+, Al3+, Ca2+ and Mg2+. 10% sulfuric acid 110 is added to the waste concrete 100 to extract and selectively separate metals (Al³⁺, Fe²⁺) 150 and ions (Mg²⁺, Ca²⁺) 152 from the aqueous phase (leachate) via sequential vacuum filtration steps and pH control. Concrete 100 is initially dissolved by the acid, and metals can be selectively extracted from the resulting solution by filtration and pH control, i.e. leachate dosing. Electrodialysis 154 may also be employed to better separate ions, discussed further below. Regeneration of the acid 110 via a loop 202 returns acid to the leaching stage. To isolate silicates and aggregates, the process doses the leachate with alkali 156 followed by a second phase removal 203 for alkaline extraction of soluble silicates. Addition of a strong base (4M NaOH) is used to selectively precipitate and isolate silicates to produce silica-rich products 158. Silica and aggregates can be isolated by raising the pH and filtration, termed supernatant dosing, also discussed further below. The supernatant is the clear, liquid solution remaining above a solid precipitate or sediment after centrifugation, precipitation, or crystallization. It is generally less dense than the solid pellet at the bottom and contains soluble components. A closed loop construct 204 allows restarting of the cycle with remaining aggregate residue 122 and new material. Multiple iterations of waste concrete 100 may occur as the cement-bonded (via C—S—H bonds) material separates from the aggregate sand, rock and gravel materials often present in concrete.

An example configuration employs sulfuric acid for generating a precipitate of gypsum and the aqueous phase includes dissolved ions for forming the gypsum from the C—S—H matrix, however any suitable acid 110, in particular hydrochloric acid (HCl) may also be employed. In general, the acid is expected to be an aqueous acid of 0.1%-10.0% concentration.

Examining the process of FIG. 2 in further detail, an example configuration begins with ~100 g of concrete waste in the form of chunks of approximately 20 mm and 100 mm in diameter. The process dissolves 100 g of concrete waste by immersing in 300 ml of 10% sulfuric acid (0.33 M) through the reactions described in Eq A-3. Sulfuric acid breaks down calcium silicate hydrate (C—S—H). C—S—His a disordered, colloidal, and amorphous-to-semicrystalline material with variable stoichiometry that acts as a binder, holding concrete components together. The solids fraction may be removed from aqueous acid one by vacuum filtration using Whatman filter paper. The filtrate is placed in 4M NaOH for 3 hours to remove silicate fraction.

This initial solid phase from acid treatment contains several materials that are valuable in purified form. One of these is gypsum (calcium sulfate dihydrate or CaSO₄-2H₂O) see Eq 2. When C—S—H is dissolved by sulfuric acid, calcium ions are liberated. These ions react with sulfate to form calcium sulfate dihydrate or gypsum, which is a solid and can be isolated by filtration.

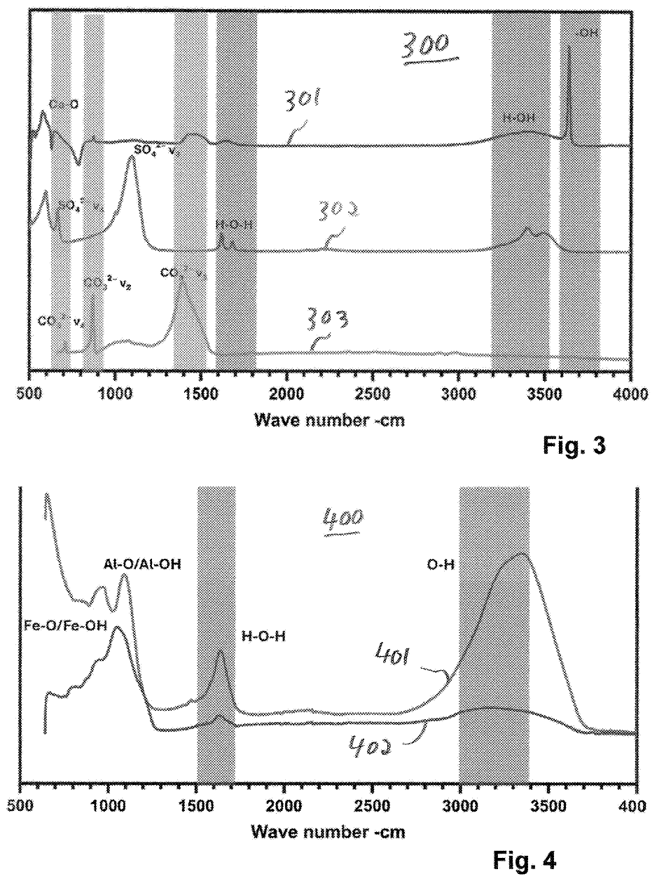

FIG. 3 shows an FT-IR spectra 300 of reference calcium phases: Ca(OH)₂ 301, CaCO₃ 303, and gypsum, CaSO₄·2H₂O 302 gathered from the process of FIG. 2. To verify that the precipitate is gypsum, FIG. 3 depicts a relevant FT-IR analysis. The spectrum displays strong absorption bands at 1109 cm⁻¹ and 3520 cm⁻¹, corresponding to SO⁴₂₋ν₃ stretching and O—H stretching vibrations, respectively. Additional sulfate ν₄ bending vibrations are observed at 690 cm⁻¹ and 600 cm⁻¹. Hydration features appear in the water regions and Ca(OH)₂ is distinguished by a sharp structural O—H stretching band at ~3640 cm⁻¹. Furthermore, there are 2 bands indicative of O—H bending vibrations (1600-1700 cm⁻¹). Comparing these results to a gypsum reference standard, it is found that that all the peaks are superimposed, indicating successful gypsum formation.

Another component that can be isolated from concrete is calcium carbonate or calcite (CaCO₃). Calcium carbonate can be formed from concrete waste after dissolution by sulfate by bubbling CO₂ or by adding NaOH. Calcium carbonate appears as a fine white powder. FIG. 3 verifies this as the spectrum shows absorption peaks at 1420 cm⁻¹ (CO₃²⁻ asymmetric stretch), 874 cm⁻¹ (CO₃²⁻ asymmetric stretch), and 712 cm⁻¹ (CO₃²⁻ symmetric stretch) which match those of the CaCO₃ standard thus confirming the formation of crystalline calcium carbonate as the dominant carbonate phase. 15 The spectra also show a sharp band at 874 cm⁻¹, which typically corresponds to a well-ordered rhombohedral structure typical of low-Mg calcite. This band suggests a small amount of magnesium as well as calcium carbonate.

Continuing further with the process of FIG. 2, the approach titrates the acidic aqueous phase (leachate) from Step 1B with NaOH until the pH reaches 4.0. H₂SO₄ is an oxidizing acid, so the leachate contains aqueous ferrous (Fe2+) and sulfate. As the pH is raised, Fe(II) is oxidized to Fe(III) and this conversion increases significantly with increasing pH:

$$4 {Fe}^{2 +} + O 2 + 10 H 2 O \to 4 Fe ( OH ) 3 ( S ) + 8 {H}^{+}$$

allowing the precipitation of Fe(OH)₃(s) along with small amounts of Fe₈O₈ (OH)₆ (SO₄)·n H₂O (schwertmannite). Over time, schwertmannite and a portion of Fe(OH)₃ (s) is converted into FeOOH(s) (goethite) The solids are filtered by vacuum and dried. The soluble phase can be titrated with 1M NaOH until the pH reaches 6.0. Increasing the pH to 6.0 for precipitating aluminum as Al(OH)₃. Between pH 6.0-7.0, Al(OH)₃ (S) (boehmite) will begin to form. The solids can be filtered and dried.

FIG. 4 shows an FT-IR spectra 400 of Al(OH)₃ 401 and Fe(OH)₃ 402 showing characteristics of metal oxygen and hydroxyl binding vibrations. Once recovering the aqueous phase an an acid of at least 10% strength is to the aqueous phase to separate metal ions including iron and aluminum, and the aqueous phase is titrated with NaOH until the pH increases to 4.0 for precipitating iron as Fe(OH)₃.

Referring to FIG. 4, the FT-IR spectra for aluminum hydroxide (Al(OH)₃) and iron (III) hydroxide (Fe(OH)₃) is obtained as described above. Both spectra exhibit characteristic hydroxy-related vibrational features along with metal-oxygen related bonding and hydration motifs. In the region below 700 cm⁻¹, the Fe(OH)₃ spectrum shows a strong absorption band compared to the Al(OH)₃. This corresponds to the Fe—O lattice vs the Al—O one. The region between 800-1100 cm⁻¹ represents metal oxygen and metal hydroxide vibrations. A similar pattern is followed but Fe(OH)₃ is more intense. In contrast, Al(OH)₃ displays smoother and less intense features that are characteristic of Al—O—H vibrational modes. There is a distinct difference at 1600-1650 cm⁻¹ that corresponds to H—O—H vibrational bending, suggesting that Fe(OH)₃ has a a some degree of structural water. Both compounds show vibrational peaks in the 3000-3600 range corresponding to hydroxy and water content.

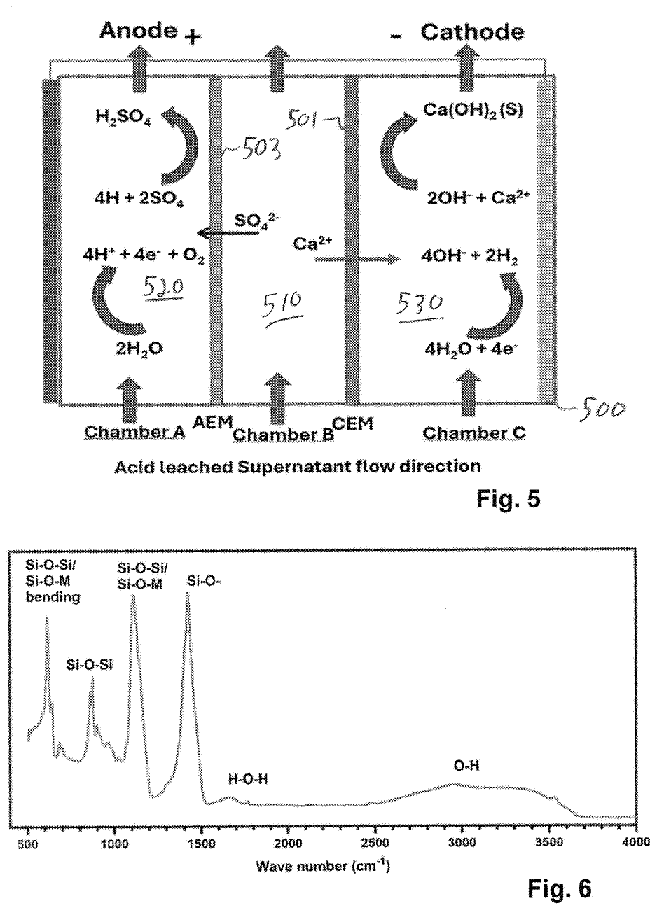

FIG. 5 is a schematic diagram of an electrochemical cell operable for the electrodialysis step of FIG. 2. Referring to FIGS. 2 and 5, electrodialysis 154 recovers calcium hydroxide from the aqueous phase via electrochemical reactions. The approach receiving a supernatant from the aqueous phase resulting from acid leaching, flows the supernatant through an electrochemical cell 500, and recovers Ca(OH)₂ from calcium ions passing through a cation exchange membrane (CEM) 502 in the electrochemical cell 500.

The cell 500 flows the supernatant through a middle chamber 510 flanked by an anode side 520 and a cathode side 530, and passes sulfate ions from the middle chamber through an anion exchange membrane (AEM) 503 to the anode side 520. Calcium ions pass through from the middle chamber 510 to the cathode side 530 through the CEM 501.

The three-chambered electrochemical cell 500 system was developed to regenerate SO₄²⁻ ions from the supernatant of the initial acid leaching step (Step 1), and generate calcium hydroxide. First, the acid-leached supernatant (leachate) was pumped through the middle chamber 510 which is flanked by an anion exchange membrane (AEM) 503 and a cation exchange membrane (CEM) 501 on the cathode side. A small voltage is applied to promote separation of the ions by charge and to promote water splitting. In this system, SO₄²⁻ migrates across the AEM to the anode chamber side 520 and the Ca2+ ion moves across the CEM to the cathode chamber side 530. Water oxidation and reduction occur in chamber A and C respectively, generating a proton and hydroxide that effectively generates acid and calcium hydroxide in tandem. Overall, this process (i) recovers and concentrates the sulfate ions to create sulfuric acid suitable for reuse, (ii) recovers calcium, and (iii) reduces ionic content in the remaining supernatant to produce a cleaned salt solution.

A further extension extract silicates from the waste concrete 100 by treating the solid residue remaining after the acid leaching and phase removal with strong alkali 156. Basic conditions selectively solubilize silicates while leaving most of the sand and coarse aggregates insoluble. FIG. 6 shows an FT-IR spectrum of recovered silicate material as in FIG. 2. Referring to FIGS. 2 and 6, after filtering solids including the gypsum and residue from the aqueous phase, where the the solids including silica and C—S—H derived materials, an alkali 156 is added to the solids for solubilizing silicates separately from sand and aggregates, separating the solubilized silicates by filtration; and recovering silicates through evaporation.

This step converts reactive silica/C—S—H derived materials into soluble silica species (sodium/calcium silicate). Following base treatment, the solids and the soluble section are separated by filtration. The soluble fraction containing recovered silicates can be crystalized on an evaporation dish. Any insoluble fractions can be run through the process again. The corresponding FT-IR spectrum (FIG. 6) of the silicates show characteristic vibrational characteristics of a partially depolymerized, calcium-modified silicate network. Peaks at 1125 cm⁻¹ and 980-1000 cm⁻¹ correspond to Si—O—Si asymmetric stretching and Si—O-M stretching involving non-bridging oxygens. Features at 615 cm⁻¹ and 870-900 cm⁻¹ indicate Si—O—Si/Si—O-M bending and metal coordinated silicate units. A weaker band at 1425 cm⁻¹ is attributed to Si—O⁻ . . . . Ca²⁺ surface complexes formed via silanol deprotonation under alkaline conditions. Together, these features confirm the presence of both bridging and terminal oxygen silica systems and are consistent with a calcium-stabilized silicate structure.

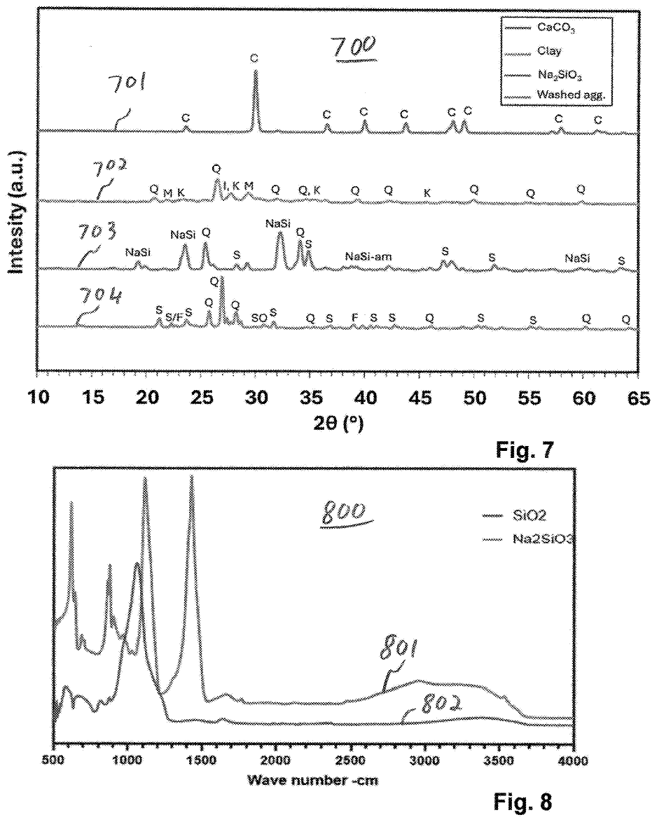

FIG. 7 shows a confirmation of products via an X-ray diffraction (XRD) of product yield from the process of FIG. 2, depicting patterns of the constituent materials and the long-term sulfate-washed recycled aggregates. In FIG. 7, an XRD graph 700 depicts calcite (CaCO₃) 701, Clay 702, sodium silicate (Na₂SiO₃) 703 and long term sulfate washed aggregate, C: CaCO₃, Q: Quartz, M: Montmorillonite, I:, K:, NaSi: Crystalline sodium silicate, S: Silicate, NaSi-am: Amorphous sodium dilicate, F: Feldspar, SO: SO₄.

The CaCO₃ sample exhibits sharp and intense peaks corresponding to calcite (C), with the most prominent reflection at 2θ≈29.4°, confirming its highly crystalline nature. Additional characteristic peaks appear at ~36°, 39°, 43°, and 48°, indicating phase purity and well-defined crystallinity. The clay sample shows a more complex mineralogical composition, with identifiable peaks corresponding to quartz (Q), kaolinite (K), and montmorillonite (M). The strong quartz peak at 2θ≈26.6° confirms that silica is the dominant crystalline phase, while the broader, lower-intensity reflections associated with clay minerals.

The sodium silicate (Na₂SiO₃) sample displays both crystalline (NaSi) and amorphous (NaSi-am) phases. A broad hump in the 20-40° 2θ range indicates significant amorphous content, consistent with the structure of sodium silicate. The long-term sulfate-washed recycled aggregate exhibits a combination of phases, including quartz (Q), feldspar (F), silicate(S), and sulfate (SO₄) phases. The dominant quartz peak at ~26.6° confirms the persistence of silica-rich crystalline phases even after washing. Broader features and minor peaks indicate residual adhered mortar, partial amorphous content, and a heterogeneous mineral composition. The presence of feldspar and silicate highlights the mixed origin of the recycled aggregate, while detectable sulfate phases reflect chemical changes during long-term exposure.

Further extensions include generating silicon dioxide from the silicates. The product from the alkali wash is Na₂SiO₃ (sodium silicate). Under normal conditions silicate species are protonated, silanol groups form, and silanol groups condense into Si—O—Si (an amorphous hydrated network):

$${Na}_{2} {SiO}_{3} + HCl - > {SiO}_{2} + NaCl + {H}_{2} O$$

A silicon dioxide (quartz) product may be attained by controlling the pH to avoid dense gel lumps and maintaining the pH near neutral but not too acidic, and allowing for slow nucleation to control particle growth.

The process commences with filter sodium silicate solution from the silica-rich products 158 (FIG. 2). Starting conditions include a temperature: 70-80° C. and an Initial pH: 11.5-13 while stirring or agitating moderately to keep suspension uniform. Upon heating to 70-80° C., allow the suspension to stabilize for about 5-15 minutes. Begin titrating 0.5-1M HCl slowing and drop the pH to around 10.0 while maintaining the temperature or allowing no more than slight cooling. Next, reduce the pH to around 9.0 and let stabilize. Further acidify the solution more and let it reach the end point pH between 7.5-8.5. Finally, age the solution by allowing it to mix for about 45 min while stirring or agitating, and maintaining the temperature at 75-80° C. Cool slightly to 50° C. and filter for completing the conversion from sodium silicate to silica dioxide.

FIG. 8 shows an FT-IR spectrum 800 comparing sodium silicate 801 from the alkali treatment and synthesized silica 802. The disappearance of sharp silicate peaks and the presence of a broad Si—O—Si stretching band around 1000-1100 cm⁻¹ in the SiO₂ spectrum confirm successful conversion to amorphous silica.

Further synthesis, leaching and precipitation performs similar extraction for magnetite from the iron rich filtrate 150.

An iterative loop process is achieved by directing the sand and aggregates to the aqueous acid as the waste concrete for subsequent gypsum and aqueous phase generation.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method for recycling concrete including aggregates bound by C—S—H bonds for generating useful constituent building materials, comprising:
adding an aqueous acid to waste concrete for generating gypsum from a calcium silicate hydrate (C—S—H) matrix in the concrete;
chemically dissolving the C—S—H matrix to yield an aqueous phase;
maintaining a concentration of sulfate ions for favoring precipitation of gypsum rather than ettringite resulting from the dissolution; and
filtering the gypsum in a solid form.

2. The method of claim 1 wherein the acid is sulfuric acid for generating a precipitate of gypsum and the aqueous phase includes dissolved ions.

3. The method of claim 1 wherein the acid is an aqueous acid of 0.1%-10.0% concentration.

4. The method of claim 1 wherein the acid is sulfuric acid for forming the gypsum from the C—S—H matrix.

5. The method of claim 1 further comprising:
recovering the aqueous phase;
adding an acid of at least 10% strength to the aqueous phase to separate metal ions including iron and aluminum;
titrating the aqueous phase with NaOH until the pH increases to 4.0 for precipitating iron as Fe(OH)₃.

6. The method of claim 5 further comprising increasing the pH to 6.0 for precipitating aluminum as Al(OH)₃.

7. The method of claim 1 further comprising recovering calcium hydroxide from the aqueous phase via electrochemical reactions.

8. The method of claim 1 further comprising:
receiving a supernatant from the aqueous phase resulting from acid leaching;
flowing the supernatant through an electrochemical cell; and
recovering Ca(OH)₂ from calcium ions passing through a cation exchange membrane (CEM) in the electrochemical cell.

9. The method of claim 7 further comprising:
flowing the supernatant through an electrochemical cell having a middle chamber flanked by anode side and a cathode side;
passing sulfate ions from the middle chamber through an anion exchange membrane (AEM) to the anode side; and
passing the calcium ions through from the middle chamber to the cathode side through the CEM.

10. The method of claim 1 further comprising:
filtering solids including the gypsum and residue from the aqueous phase, the solids including silica and C—S—H derived materials;
adding an alkali to the solids for solubilizing silicates separately from sand and aggregates; and
separating the solubilized silicates by filtration; and
recovering silicates through evaporation.

11. The method of claim 10 further comprising directing the sand and aggregates to the aqueous acid as the waste concrete for subsequent gypsum and aqueous phase generation.

12. The method of claim 10 further comprising generating silicon dioxide from the silicates.

13. TMOC 5 further comprising generating magnetite powder from the aqueous phase.

14. A method of recycling concrete, comprising:
adding sulfuric acid to a concrete recycling stream including structural concrete formed with a calcium silicate hydrate (C—S—H) matrix;
chemically dissolving the C—S—H matrix for concrete recycling; and
maintaining a concentration of sulfate ions for favoring precipitation of gypsum rather than ettringite in the recycled product.

15. The method of claim 14 further comprising dissolving the structural concrete with concentrated sulfuric acid for increasing a concentration of sulfate ions and acid for reacting with the alkaline C—S—H.
